(19) United States
(12) Patent Application Publication
(10) Pub. No.: US 2023/0385901 A1
(43) Pub. Date: Nov. 30, 2023

(54) VEHICLE RECOMMENDATION SYSTEM AND VEHICLE RECOMMENDATION METHOD

(71) Applicants: HYUNDAI MOTOR COMPANY, Seoul (KR); KIA CORPORATION, Seoul (KR)

(72) Inventors: Jeewook Huh, Seoul (KR); Dong Ho Yang, Incheon (KR); Hong Suk Kwak, Seoul (KR); Dong-Su Ha, Hwaseong-si (KR)

(73) Assignees: HYUNDAI MOTOR COMPANY, Seoul (KR); KIA CORPORATION, Seoul (KR)

(21) Appl. No.: 17/993,069

(22) Filed: Nov. 23, 2022

(30) Foreign Application Priority Data
May 27, 2022 (KR) 10-2022-0065225

(51) Int. Cl. G06Q 30/06

(52) U.S. Cl. CPC G06Q 30/0631

(57) ABSTRACT

A vehicle recommendation system includes: a user tendency determinator configured to determine a user tendency based on a response to a user tendency test received from a user terminal, a vehicle tendency determination device configured to determine a plurality of vehicle tendencies for each of a plurality of vehicles, and an optimal tendency matcher configure to generate a tendency matching index indicating a degree of matching between the user tendency and the vehicle tendency for each of the plurality of vehicles.

### CROSS-REFERENCE TO RELATED APPLICATION

This application claims priority to and the benefit of Korean Patent Application No. 10-2022-0065225 filed in the Korean Intellectual Property Office on May 27, 2022, the entire contents of which are incorporated herein by reference.

### FIELD

The present disclosure relates to a vehicle recommendation system and a vehicle recommendation method.

### BACKGROUND

Customers who do not know much about cars may find it difficult to use a vehicle recommendation service provided by a vehicle manufacturer. For example, in a vehicle recommendation service application provided through the web, various questions requesting responses from customers who want to purchase a vehicle are specialized questions about vehicles that are difficult for customers to understand. Furthermore, customer satisfaction with the vehicle recommendation result provided to customers based on the response to the corresponding question is low. As described above, although the application is developed and provided according to the need for the vehicle recommendation service, however, it is difficult for customers to use the vehicle recommendation service through the application, and the satisfaction with the vehicle recommendation result is low.

The above information disclosed in this Background section is only to enhance understanding of the background of the present disclosure, and therefore it may contain information that does not form the prior art that is already to a person of ordinary skill in the art.

### SUMMARY

The present disclosure provides a system and a method having advantages of recommending an optimal vehicle, which a user wants to purchase a vehicle would be satisfied with.

In an embodiment of the present disclosure, a vehicle recommendation system includes a user tendency determinator configured to determine a user tendency based on a response to a user tendency test received from a user terminal. The vehicle recommendation system also includes a vehicle tendency determination device configured to determine a plurality of vehicle tendencies for each of a plurality of vehicles. The vehicle recommendation system further includes an optimal tendency matcher configured to generate a tendency matching index indicating a degree of matching between the user tendency and the vehicle tendency for each of the plurality of vehicles.

The user tendency determinator may be configured to calculate a plurality of first weight values for a plurality of user tendency elements of the user tendency based on the response to the user tendency test, and the vehicle tendency determination device may be configured to calculate a plurality of second weight values for a plurality of vehicle tendency elements of each of the plurality of vehicles. The optimal tendency matcher may be configured to generate the tendency matching index for each of the vehicles based on the plurality of first weight values for the plurality of user tendency elements and the plurality of second weight values for the plurality of vehicle tendency elements for each of the plurality of vehicles.

The user tendency determinator may be configured to sum the plurality of first weight values in a result of the response to the user tendency test for each of the user tendency elements. The user tendency determinator may be configured to compare a result of the sum with a score distribution for each of the user tendency elements of each of a plurality of user tendency groups, and may determine that a user belongs to one of the plurality of user tendency groups that shows the most similar score distribution to the result of the sum based on the comparison.

The user tendency determinator may be configured to derive a weight value distribution of the plurality of user tendency elements for each of a plurality of users, and may also be configured to determine characteristics of each of the plurality of user tendency groups by grouping the plurality of user tendency elements according to the derived weight value distribution of the plurality of user tendency elements.

The user tendency determinator may be configured to sum a result obtained by multiplying a response to each of a plurality of questions included in the user tendency test and sensitivity for each of the plurality of user tendency elements of each question, and may also be configured to determine the user tendency based on a result of the sum for each of the plurality of user tendency elements

The vehicle tendency determination device may be configured to calculate the plurality of second weight values for the plurality of vehicle tendency elements based on vehicle data for each of the plurality of vehicles and vehicle evaluation data for each of the plurality of vehicles. The vehicle data may include at least one of vehicle specifications, price, color, performance, and maintenance cost. The vehicle evaluation data may also include at least one of evaluation data for each vehicle provided by a vehicle evaluation institution and evaluation data collected from users.

The optimal tendency matcher may be configured to generate the tendency matching index by calculating standard deviation for differences between the plurality of first weight values for the plurality of user tendency elements and the plurality of second weight values for the plurality of vehicle tendency elements for each of the plurality of vehicles.

The optimal tendency matcher may be configured to generate the tendency matching index by calculating a sum of results obtained by multiplying the plurality of first weight values for the plurality of user tendency elements and the plurality of second weight values for the plurality of vehicle tendency elements.

The optimal tendency matcher may be configure to calculate a sum of results obtained by multiplying the plurality of first weight values for the plurality of user tendency elements and the plurality of second weight values for the plurality of vehicle tendency elements. The optimal tendency matcher may also be configure to derive a plurality of candidate vehicles among the plurality of vehicles based on the sum, and to generate the tendency matching index by calculating standard deviation for differences between the plurality of first weight values for the plurality of user tendency elements and the plurality of second weight values for the plurality of vehicle tendency elements for each of the plurality of derived candidate vehicles.

The vehicle recommendation system may further include a budget factor determinator configured to derive a budget factor for the plurality of vehicles. The budget factor may be an index indicating a degree to which a user's budget for vehicle purchase matches a vehicle price.

The budget factor determinator may be configured to derive a vehicle price range obtained by applying predetermined standard deviation to the budget for vehicle purchase received from the user terminal. The budget factor determinator may also be configured to derive the budget factor for the vehicle price using a budget factor function when the vehicle price belongs to the derived vehicle price range.

The budget factor determinator may be configured to receive a budget range for vehicle purchase from the user terminal, and to set the budget for vehicle purchase based on the budget range for vehicle purchase. The budget factor determinator may also be configured to set the budget range for vehicle purchase as a vehicle price range, and to derive standard deviation according to a difference between the budget range for vehicle purchase and the budget for vehicle purchase. The budget factor determinator may be configured to derive the budget factor based on the budget for vehicle purchase, the standard deviation, and the vehicle price.

The budget factor determinator may be configured to receive the budget for vehicle purchase from the user terminal, and to derive a vehicle price range having a predetermined margin based on the budget for vehicle purchase. The budget factor determinator may also be configured to derive the budget factor proportional to the vehicle price when the vehicle price falls within a proportional section of the vehicle price range.

The budget factor determinator may be configured to receive a budget range for vehicle purchase from the user terminal, and to set the budget range for vehicle purchase as a vehicle price range. The budget factor determinator may be configured to determine the budget factor as one “1” for the vehicle falling within the vehicle price range, and to determine the budget factor as zero “0” for the vehicle beyond the vehicle price range.

The budget factor determinator may be configured to receive the budget for vehicle purchase from the user terminal, and to derive a vehicle price range having a predetermined margin based on the budget for vehicle purchase. The budget factor determinator may also be configured to divide the vehicle price range into a plurality of ranges to set the budget factor according to each range, and to derive the budget factor of the range to which the vehicle price belongs of the plurality of ranges as the budget factor of the vehicle.

The budget factor determinator may be configured to receive a budget range for vehicle purchase from the user terminal, and to determine the budget for vehicle purchase by multiplying a median value of the budget range for vehicle purchase by a predetermined ratio. The budget factor determinator may also be configured to set the budget factor according to a section from the minimum value of the budget range for vehicle purchase to the budget for vehicle purchase and a section from the budget for vehicle purchase to the maximum value of the budget range for vehicle purchase.

The vehicle tendency determination device may include a vehicle cost calculator configured to calculate vehicle purchase cost and vehicle maintenance cost to calculate a weight value for economics among the vehicle tendencies. The vehicle cost calculator may be configured to calculate the vehicle purchase cost by summing up vehicle price and vehicle registration cost and to calculate the vehicle maintenance cost by summing up at least two of fuel cost, insurance premium, tax imposed on the vehicle, and repair cost during a predetermined vehicle replacement period.

The vehicle cost calculator may be configured to calculate fuel efficiency based on annual travel distance received from the user terminal to calculate the fuel cost based on the fuel efficiency. The vehicle cost calculator may be configured to calculate a city driving ratio by dividing a difference between the annual travel distance and a first reference distance by a difference between a second reference distance and the first reference distance. The vehicle cost calculator may also be configured to calculate a highway driving ratio by deducting the city driving ratio from one “1”, and to calculate the fuel efficiency by summing up a value obtained by multiplying the city driving ratio and city driving fuel efficiency and a value obtained by multiplying the highway driving ratio and highway driving fuel efficiency.

The first reference distance may be determined based on the annual travel distance in which the city driving ratio is one “1”, and the second reference distance may be determined based on the annual travel distance in which the highway driving ratio is one “1”.

In another embodiment of the present disclosure, a vehicle recommendation method includes: receiving a response to a user tendency test from a user terminal, and determining a user tendency based on a response to a user tendency test. The vehicle recommendation method further includes: determining a plurality of vehicle tendencies for each of a plurality of vehicles, and generating a tendency matching index indicating a degree of matching between the user tendency and the vehicle tendency for each of the plurality of vehicles.

The generating of the tendency matching index may include generating the tendency matching index based on a plurality of first weight values for a plurality of user tendency elements of the user tendency and a plurality of second weight values for the plurality of vehicle tendency elements for each of the plurality of vehicles.

The generating of the tendency matching index may include calculating standard deviation for differences between the plurality of first weight values for the plurality of user tendency elements and the plurality of second weight values for the plurality of vehicle tendency elements for each of the plurality of vehicles.

The generating of the tendency matching index may include calculating a sum of results obtained by multiplying the plurality of first weight values for the plurality of user tendency elements and the plurality of second weight values for the plurality of vehicle tendency elements.

The generating of the tendency matching index may include calculating a sum of result obtained by multiplying a plurality of first weight values for a plurality of user tendency elements and a plurality of second weight values for a plurality of vehicle tendency elements. The generating of the tendency matching index may also include: deriving a plurality of candidate vehicles among the plurality of vehicles based on the sum, and calculating standard deviation for differences between the plurality of first weight values for the plurality of user tendency elements and the plurality of second weight values for the plurality of vehicle tendency elements for each of the plurality of derived candidate vehicles.

The vehicle recommendation method may further include: deriving a budget factor for each of the plurality of vehicles, and excluding a vehicle having the budget factor less than a predetermined threshold value among the plurality of vehicles at the generating of the tendency matching index.

According to an embodiment of the present disclosure, it is possible to provide a vehicle recommendation system and a vehicle recommendation method capable of recommending an optimal vehicle model in consideration of user tendency.

### BRIEF DESCRIPTION OF THE DRAWINGS

In order that the disclosure may be well understood, there will now be described various forms thereof, given by way of example, reference being made to the accompanying drawings, in which:

FIG. 1 is a diagram illustrating a vehicle recommendation system according to an embodiment of the present disclosure;

FIG. 2 is a graph illustrating a user tendency element and a vehicle tendency element according to an embodiment of the present disclosure;

FIG. 3 is a graph illustrating a method of determining a budget factor according to a proportional calculation method by a budget factor determinator according to an embodiment of the present disclosure;

FIG. 4 is a graph illustrating a method of determining a budget factor according to a clustering method by a budget factor determinator according to an embodiment of the present disclosure;

FIG. 5 is a flowchart illustrating a vehicle recommendation method according to an embodiment of the present disclosure;

FIG. 6 is a diagram illustrating a method of generating a tendency matching index in an embodiment of the present disclosure;;

FIG. 7 is a flowchart illustrating a vehicle recommendation method in consideration of a budget factor according to an embodiment of the present disclosure; and

FIG. 8 is a block diagram illustrating some configuration of a vehicle tendency determination device according to an embodiment of the present disclosure.

The drawings described herein are for illustration purposes only and are not intended to limit the scope of the present disclosure in any way.

### DETAILED DESCRIPTION

Hereinafter, embodiments of the present disclosure are described in detail referring to the drawings, in which like reference numerals designate like constituent elements, and a repeated description related thereto has been omitted. The suffix “module” and/or “part” for the constituent elements used in the following description are given or used interchangeably merely in consideration of ease of specification, and do not have their own meanings or roles. In describing embodiments of the present disclosure, if a detailed explanation for a related known function or construction is considered to unnecessarily divert the gist an embodiment of the present disclosure, such detailed description has been omitted but would be understood by those having ordinary skill in the art. The accompanying drawings of the present disclosure aim to facilitate understanding an embodiment of the present disclosure and should not be construed as limited to the accompanying drawings, and all changes included in the spirit and scope of the present disclosure should be understood to include equivalents or substitutes.

It should be understood that although terms such as first, second, and the like may be used herein to describe various constituent elements, these constituent elements should not be limited by these terms. Each of these terminologies is used merely to distinguish the corresponding constituent element from other constituent element(s).

When it is mentioned that one constituent element is “connected” or “coupled” to another constituent element, it should be understood that the one constituent element may be directly connected or coupled to the other constituent element or that still another component is interposed between the two constituent elements. In contrast, it should be noted that if it is described in the specification that one constituent element is “directly connected” or “directly coupled” to another constituent element, no other constituent element is present therebetween.

It should be further understood that the terms “comprises” or “comprising,” when used in this specification, specify the presence of stated features, integers, steps, operations, elements, components or a combination thereof, but do not preclude the presence or addition of one or more other features, integers, steps, operations, elements, components, and/or groups thereof.

In addition, the terms “-er”, “-or”, and “module” described in the specification mean units for processing at least one function and operation, and can be implemented by hardware components or software components, and combinations thereof. When a component, device, element, or the like of the present disclosure is described as having a purpose or performing an operation, function, or the like, the component, device, or element should be considered herein as being “configured to” meet that purpose or to perform that operation or function.

Hereinafter, a user tendency in the specification may include personal tendencies that may be considered when purchasing a vehicle among various personal tendencies. Each of the individual tendencies is referred to as a user tendency element. In the specification, a vehicle tendency may include a qualitative characteristic of the vehicle corresponding to the user tendency. The vehicle tendency may include a plurality of vehicle tendency elements corresponding to the plurality of user tendency elements. The user refers to a customer who wants to receive a vehicle recommendation using a vehicle recommendation system according to an exemplary embodiment.

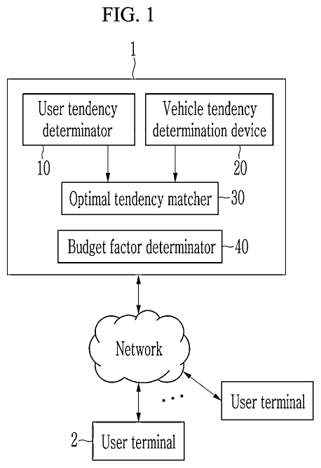

First, referring to FIG. 1, a vehicle recommendation system is described below.

FIG. 1 is a drawing illustrating a vehicle recommendation system according to an embodiment.

A vehicle recommendation system 1 may include at least one of a user tendency determinator 10, a vehicle tendency determination device 20, an optimal tendency matcher 30, and a budget factor determinator 40. The vehicle recommendation system 1 may transmit and receive information to and from a plurality of user terminals 2 through a network. Although not shown in FIG. 1, the vehicle recommendation system 1 may receive necessary information for vehicle recommendation from an external server through a network. In FIG. 1, the components 10-40 are shown to be all included in the vehicle recommendation system 1, but some of the components 10-40 are externally implemented. Information necessary for other components and vehicle recommendation may be transmitted and received through a network. The vehicle recommendation system 1 may store software including a program for performing an operation according to an embodiment, and operate the program. Functions performed according to the operation of the program may be divided into the respective operations of the user tendency determinator 10, the vehicle tendency determination device 20, the optimal tendency matcher 30, and the budget factor determinator 40.

The vehicle recommendation system 1 according to an exemplary embodiment may include the user tendency determinator 10.

The user tendency determinator 10 may transmit a user tendency test including a question about the user for recommending a vehicle suitable for the user (hereinafter, a user question) and questions for determining the user tendency to the user terminal 2. The user tendency determinator 10 may also receive a user question and a response to the user tendency test from the user terminal 2, thereby determining the user tendency based on the received response. The user terminal 2 receives a signal received from the outside through a network, and the signal received by the user terminal 2 is processed as information by an application processor (AP). The AP may deliver the information to the corresponding application. The application may perform a determination based on information received from the AP, and may display the result of the determination on the user terminal 2, or transmit it to the outside through the user terminal 2. For example, the application according to an embodiment may perform a determination according to information received from the vehicle recommendation system 1 through the user terminal 2 and may display the result of the determination on the user terminal 2. The application may also process and transmit information based on input from the user terminal 2 to the vehicle recommendation system 1 through the user terminal 2.

The user question is a direct question necessary for purchasing a vehicle. The user question is a question to acquire information necessary to reduce the vehicle category, and the user tendency test is a question to understand the user tendency. For example, the user question may include questions about the user's budget for vehicle purchase, the number of people to ride in the vehicle, the age of the user, the use of the vehicle, the travel distance of the vehicle per unit period, and the like.

The user tendency may be determined by a plurality of user tendency elements. The plurality of user tendency elements may include economics indicating the customer's interest in the price of the vehicle, safety indicating the customer's interest level in the defense function of the vehicle against external risks or accidents, self-consciousness indicating the customer's interest level in the evaluation about other customers, technicality indicating the customer's interest level in new technology applied to the vehicle, reliability indicating the customer's interest level in the quality evaluation of the vehicle, and functionality indicating the customer's interest level in the performance of the vehicle, and aesthetics indicating the customer's interest level in the design of the vehicle. However, the plurality of user tendencies is not limited to the contents listed above. In other words, various elements that may be considered in determining the user tendency may be further considered in determining the user tendency. The user tendency test may not be a question to directly ask the user tendency, but may be a question about the customer's value judgment indirectly related to the user tendency.

The user tendency determinator 10 may calculate a plurality of weight values for a plurality of user tendency elements based on a response to the user tendency test, and may determine the user tendency based on the calculated plurality of weight values. In addition, the user tendency determinator 10 may perform a clustering operation of classifying a plurality of users into a predetermined number of groups (hereinafter, user tendency groups) indicating the user tendency in determining the user tendency.

Table 1 illustrates the correlation between the user tendency test and the user tendency. In Table 1, “A” is a question for the user tendency test, asking the customer's reaction under the condition, “B1” is a response that is not related to the user tendency among the user's responses, and “B2” is a response that is related to the user tendency among the customer's responses, “Ca” is a weight value indicating relevance to economics, “Cb” is a weight value indicating relevance to safety, “Cc” is a weight value indicating relevance to self-consciousness, “Cd” is a weight value indicating relevance to technicality, “Ce” is a weight value indicating relevance to reliability, “Cf” is a weight value indicating relevance to functionality, “Cg” is a weight value indicating relevance to aesthetics.

TABLE 1

| A | B1 | B2 | Ca | Cb | Cc | Cd | Ce | Cf | Cg |
|---|---|---|---|---|---|---|---|---|---|
| When you | Have no | Envy | 0 | 0 | 4 | 0 | 0 | 0 | 0 |
| see other | idea | | | | | | | | |
| people's | | | | | | | | | |
| good things | | | | | | | | | |
| When you | Feel | Advise | 3 | 0 | 0 | 0 | 0 | 0 | 0 |
| listen to | sympathy | | | | | | | | |
| other | | | | | | | | | |
| people's | | | | | | | | | |
| concerns | | | | | | | | | |
| When a new | Use | Want to buy | 0 | 0 | 2 | 3 | 0 | 1 | 0 |
| phone is | current cell | | | | | | | | |
| released | phone | | | | | | | | |
| When you | Let it slide | Request | 0 | 0 | 0 | 0 | 5 | 0 | 0 |
| are harmed | | compensation | | | | | | | |
| by others | | for | | | | | | | |
| | | material/mental | | | | | | | |
| | | damage | | | | | | | |
| When you | Can let it | Get angry | 0 | 0 | 0 | 0 | 4 | 0 | 0 |
| see a | slide | | | | | | | | |
| person | | | | | | | | | |
| repeating | | | | | | | | | |
| small | | | | | | | | | |
| mistakes | | | | | | | | | |
| If there is a | Don't care | Must take | 0 | 0 | 0 | 0 | 0 | 1 | 0 |
| notification | | a look | | | | | | | |
| floating in | | | | | | | | | |
| the app | | | | | | | | | |
| To safety, | Attach | Attach no | 0 | 5 | 0 | 0 | 1 | 0 | 0 |
| our society | importance | importance | | | | | | | |
| About daily | Good | Bored | 0 | 0 | 0 | 3 | 0 | 0 | 0 |
| routine | | | | | | | | | |
| If you can't | Keep | Give up easily | 3 | 0 | 0 | 0 | 0 | 0 | 0 |
| buy what | thinking | | | | | | | | |
| you want | | | | | | | | | |
| About | Dislike | Like | 0 | 0 | 0 | 5 | −1 | 0 | 0 |
| solving | | | | | | | | | |
| complex | | | | | | | | | |
| problems | | | | | | | | | |
| When you | It can | Want to win | 0 | 0 | 0 | 0 | 0 | 2 | 0 |
| lose the | happen | | | | | | | | |
| game | | | | | | | | | |
| On the | Keep | Move | 0 | 0 | 0 | 0 | 0 | 4 | 0 |
| escalator | standing | | | | | | | | |
| About | Stress | Foolishness | 3 | 0 | 0 | 0 | 0 | 0 | 0 |
| impulse | relief | | | | | | | | |
| purchase | | | | | | | | | |
| To the | tend to be | Arrive early | 0 | 0 | 0 | 0 | 2 | 0 | 0 |
| appointment | late | | | | | | | | |
| time | | | | | | | | | |
| About food | Reluctant | Try it | 0 | 0 | 0 | 0 | 0 | 0 | 2 |
| you see for | | | | | | | | | |
| the first time | | | | | | | | | |
| About an | excited | Anxious | 5 | 0 | −1 | −1 | 1 | 0 | 0 |
| unplanned | | | | | | | | | |
| trip | | | | | | | | | |
| If you have | Feel the | Enjoy | 0 | 0 | 0 | 5 | −1 | 0 | 0 |
| to adapt to a | stress | | | | | | | | |
| new | | | | | | | | | |
| environment | | | | | | | | | |

Table 1 above is an example of the user tendency test, and the present disclosure is not limited thereto.

Table 2 below shows the user tendency groups classified by the user tendency determinator 10 through the clustering method. The user tendency determinator 10 may sum the weight values in a response result to the user tendency test received through the user terminal 2 for each of the user tendency elements. The user tendency determinator 10 may compare a sum result with a score distribution for each of the user tendency elements of each user tendency group in Table 2 below, and may determine that the user belongs to the user tendency group that shows the most similar score distribution to the sum result based on the comparison result. The user tendency determinator 10 may calculate standard deviation between the sum result for each user tendency element and the score for each user tendency element of the user tendency group in order to derive the comparison result. The user tendency determinator 10 may determine the user tendency group having the smallest standard deviation as the user tendency.

TABLE 2

| | | | Self- | | | | |
|---|---|---|---|---|---|---|---|
| | | | conscious- | | | Function- | |
| | Economics | Safety | ness | Technicality | Reliability | ality | Aesthetics |
| Group | 1 | 3 | 4 | 1 | 0 | 2 | 1 |
| 1 | | | | | | | |
| Group | 2 | 4 | 1 | 3 | 2 | 0 | 0 |
| 2 | | | | | | | |
| Group | 1 | 1 | 2 | 0 | 2 | 1 | 2 |
| 3 | | | | | | | |
| Group | 2 | 0 | 1 | 2 | 3 | 0 | 1 |
| 4 | | | | | | | |
| Group | 3 | 2 | 5 | 1 | 0 | 2 | 0 |
| 5 | | | | | | | |
| Group | 2 | 3 | 2 | 2 | 2 | 3 | 2 |
| 6 | | | | | | | |
| Group | 2 | 1 | 0 | 5 | 1 | 3 | 4 |
| 7 | | | | | | | |

The user tendency determinator 10 may accumulate responses to the user tendency test to determine the plurality of user tendency groups, and may apply the clustering to the accumulated data when the accumulated data has a predetermined size or more. The user tendency determinator 10 may derive a weight value distribution of the plurality of user tendency elements for each of the plurality of users based on the accumulated data, and may determine the characteristics of each group by grouping them by weight value distribution of the derived plurality of user tendency elements. When response data to the user tendency test of a sufficient size is not accumulated, the user tendency determinator 10 may derive the plurality of user tendency groups by using data accumulated in another external database.

The user tendency determinator 10 according to an embodiment may determine the user tendency by collecting responses of the user tendency test for each user tendency element. The user tendency determinator 10 may sum a result obtained by multiplying the responses to each of the plurality of questions included in the user tendency test and the sensitivity for each of the plurality of user tendency elements of each question. The user tendency determinator 10 may determine the user tendency based on the sum result for each of the plurality of user tendency elements.

Table 3 below is a table showing the sum result for each of the plurality of user tendency elements based on the sensitivity of the plurality of user tendency elements to each question and the user's response.

As shown in Table 3, the user tendency may be determined to have a pattern of technicality>safety>self-consciousness.

TABLE 3

| | | | | Self- | | | | |
|---|---|---|---|---|---|---|---|---|
| | User | | | conscious- | | | Function- | |
| | response | Economics | Safety | ness | Technicality | Reliability | ality | Aesthetics |
| Question | 2 | 5 | 0 | 1 | 1 | 0 | 0 | 0 |
| 1 | | | | | | | | |
| Question | 1 | 0 | 5 | 0 | 0 | 0 | 0 | 1 |
| 2 | | | | | | | | |
| Question | 3 | 1 | 2 | 5 | 0 | 0 | 1 | 0 |
| 3 | | | | | | | | |
| Question | 5 | 0 | 1 | 0 | 0 | 0 | 5 | 1 |
| 4 | | | | | | | | |
| Question | 0 | 1 | 0 | 0 | 5 | 1 | 0 | 1 |
| 5 | | | | | | | | |
| Question | 2 | 1 | 2 | 0 | 1 | 5 | 0 | 0 |
| 6 | | | | | | | | |
| Question | 1 | 0 | 0 | 2 | 0 | 1 | 0 | 5 |
| 7 | | | | | | | | |

| | | | | | | | |
|---|---|---|---|---|---|---|---|
| Result | 15 | 20 | 19 | 4 | 11 | 28 | 11 |

The user tendency determinator 10 may classify questions based on sensitivity for each user tendency element.

Table 4 is an exemplary example of classifying a plurality of questions based on sensitivity for each user tendency element according to an embodiment.

TABLE 4

| Sensitivity | 1 | 2 | 3 | 4 | 5 |
|---|---|---|---|---|---|
| Economics | Question 1 | Question 6 | Question 2 | Question 3 | Question 7 |
| | Question 4 | | | | |
| | Question 5 | | | | |
| Safety | Question 7 | Question 3 | Question 1 | Question 6 | Question 4 |
| | | | Question 2 | | |
| | | | Question 5 | | |
| Self- | Question 6 | Question 2 | Question 3 | Question 5 | Question 1 |
| con- | | Question 7 | | | Question 4 |
| sciousness | | | | | |
| Func- | Question 1 | Question 4 | Question 5 | Question 6 | Question 2 |
| tionality | Question 3 | | | | |
| | Question 7 | | | | |

The user tendency determinator 10 may configure a question set within a question having the same sensitivity. Table 5 is an example in which the user tendency determinator 10 classifies questions having the same sensitivity for each user tendency element to configure a question set. In the table below, the number next to “user tendency element ” may be an ordinal number indicating which of the various questions about the corresponding user tendency element is.

TABLE 5

| Sensitivity 1 | Sensitivity 2 | Sensitivity 3 | Sensitivity 4 | Sensitivity 5 | Sensitivity 6 |
|---|---|---|---|---|---|
| Question set | Question set | Question set | Question set | Question set | Question set |
| Economics 7 | Economics 7 | Economics 3 | Economics 2 | Economics 2 | Economics 2 |
| Safety 4 | Safety 4 | Safety 6 | Safety 1 | Safety 2 | Safety 5 |
| Self- | Self- | Self- | Self- | Self- | Self- |
| consciousness 1 | consciousness 4 | consciousness 5 | consciousness 3 | consciousness 3 | consciousness 3 |
| Functionality 2 | Functionality 2 | Functionality 6 | Functionality 5 | Functionality 5 | Functionality 5 |

The vehicle recommendation system 1 according to an embodiment may further include a vehicle tendency determination device 20.

The vehicle tendency determination device 20 may calculate a plurality of weight values for the plurality of vehicle tendency elements based on data for each vehicle (hereinafter, vehicle data) and evaluation data (hereinafter, vehicle evaluation data) for each of the plurality of vehicles. The vehicle tendency determination device 20 may also determine the tendency of each vehicle based on the plurality of calculated weight values. “A plurality of vehicles” may be classified according to a vehicle type, and the vehicle type may be classified according to a vehicle name and a powertrain. For example, if the vehicle model name is “AVANTE” and the powertrain types of “AVANTE” are classified into 6 types, such as gasoline, diesel, gasoline turbo, hybrid, plug-in hybrid, and electric vehicle, then the vehicle type is “6”. The vehicle recommendation system 1 according to an embodiment includes the vehicle tendency determination device 20, but the vehicle tendency determination device 20 is configured as a separate apparatus outside the vehicle recommendation system 1. The vehicle recommendation system 1 may transmit a plurality of weight value information for the plurality of vehicle tendency elements for the requested vehicle in response to a request from the vehicle recommendation system 1 through a network. Alternatively, the vehicle recommendation system 1 may build and include the plurality of weight value information for the plurality of vehicle tendency elements for each of the plurality of vehicles as a database.

The vehicle data may include data related to specifications, price, color, specifications, performance, and maintenance cost of the vehicle. The vehicle evaluation data may include evaluation data for each vehicle provided by a vehicle evaluation institution and evaluation data collected from users by the vehicle recommendation system 1. A plurality of vehicle data and the vehicle evaluation data may be stored in the database of the vehicle recommendation system 1. The vehicle recommendation system 1 may accumulate the plurality of vehicle data and the plurality of vehicle evaluation data, classify them by vehicle, and store them in a database. The vehicle recommendation system 1 may collect information on the vehicle data provided by a vehicle manufacturer, classify the information by vehicle, and store it in a database. The vehicle recommendation system 1 may request and collect the vehicle evaluation data from a server of the evaluation institution, classify the collected data by vehicle, and store the collected data in a database.

The vehicle tendency determination device 20 may calculate weight values for the plurality of vehicle tendency elements based on the vehicle data and the vehicle evaluation data. The plurality of vehicle tendency elements are elements corresponding to the plurality of user tendency elements. It is described that the plurality of vehicle tendency elements and the plurality of user tendency elements are the same in an embodiment. However, the present disclosure is not limited thereto, and although there is a correspondence relationship between the plurality of vehicle tendency elements and the plurality of user tendency elements, they may not be the same.

The vehicle tendency determination device 20 may determine a weight value for economics, which is one of the vehicle tendency elements, based on the price of the vehicle and maintenance cost for a predetermined period of the vehicle data.

The vehicle tendency determination device 20 may determine a weight value for safety, which is one of the vehicle tendency elements, based on certified data among the vehicle evaluation data and data related to safety information among the vehicle data. Safety-related certified data may be collected from Insurance Institute for Highway Safety, USA (IIHS), Korean New Car Assessment Program, Korea (KNCAP), European New Car Assessment Program, Europe (EuroNCAP), Ministry of Land, Infrastructure and Transport, Ministry of Environment, Ministry of Industry, and Insurance Development Institute, etc.

The vehicle tendency determination device 20 may determine a weight value for self-consciousness, which is one of the vehicle tendency elements, by using the vehicle evaluation data. The self-consciousness-related certified data may be collected from consumer report/USA (CR), AutoBilt (Europe), MotorTrend (USA), etc., or may be collected from the result of a survey on the brand value of vehicle manufacturers.

The vehicle tendency determination device 20 may determine a weight value for technicality, which is one of the vehicle tendency elements, based on a new technology applied to the vehicle among the vehicle data. For example, a high technical weight value is assigned to a vehicle having an automatic driving function, a hydrogen car, an electric vehicle, a vehicle embedded with a new collision avoidance system.

The vehicle tendency determination device 20 may determine a weight value for reliability, which is one of the vehicle tendency elements, based on the vehicle evaluation data. Reliability-related certified data may include JD Power's (USA) new car quality index, internal quality index, and the like.

The vehicle tendency determination device 20 may determine a weight value for functionality, which is one of the vehicle tendency elements, based on the vehicle data. The functionality-related vehicle data may include vehicle weight, vehicle engine performance, performance of a vehicle motor, and the like.

The vehicle tendency determination device 20 may determine a weight value for aesthetics, which is one of the vehicle tendency elements, based on the vehicle evaluation data. Aesthetics-related certified data may be collected from international forum, Europe (IF), international design excellence award, USA (IDEA), and the like.

The above description is an example of an embodiment, and the present disclosure is not limited thereto. The vehicle tendency determination device 20 may use at least one of the vehicle data and the vehicle evaluation data to determine the vehicle tendency element, but is is not limited thereto. For example, the weight value for the vehicle tendency element may be determined using data accumulated by the vehicle recommendation system 1 together with or instead of the official data.

The vehicle recommendation system 1 according to an embodiment may further include the optimal tendency matcher 30.

The optimal tendency matcher 30 may receive information on each of the user tendency and the plurality of vehicle tendencies from the user tendency determinator 10 and the vehicle tendency determination device 20 The optimal tendency matcher 30 may generate a tendency matching index quantified by determining the degree of matching between the user tendency and each of the plurality of vehicle tendencies. The optimal tendency matcher 30 may generate the tendency matching index according to at least one of a standard deviation method, a factoring method, and a hybrid method.

The optimal tendency matcher 30 may calculate standard deviation for a difference between a weight value for each of the plurality of user tendency elements and a weight value for each of the plurality of vehicle tendency elements according to the standard deviation method, and may generate the tendency matching index based on the calculated standard deviation.

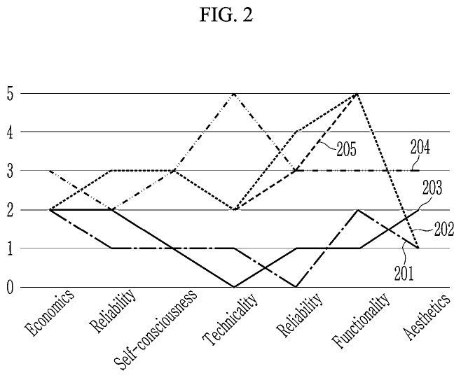

FIG. 2 is a graph illustrating the user tendency element and the vehicle tendency element according to an embodiment of the present disclosure.

In FIG. 2, the plurality of user tendency elements and the plurality of vehicle tendency elements are respectively indicated on the x-axis, and weight values for each of the plurality of user tendency elements and the plurality of vehicle tendency elements are indicated on the y-axis.

In FIG. 2, the optimal tendency matching unit 30 may calculate standard deviation between each of graphs 202-205 representing weight values for the plurality of vehicle tendency elements and a weight value for each of the plurality of user tendency elements.

It can be seen that standard deviation between the graph 201 and the graph 203 is the smallest based on the standard deviation calculation result by the optimal tendency matcher 30. A vehicle corresponding to the graph 203 having the smallest standard deviation may be determined as the optimal vehicle type. According to the standard deviation method, a vehicle most suitable for the user tendency may be determined as the optimal vehicle type. However, according to the standard deviation method, when the weight values of the plurality of user tendency elements are low, a vehicle with a relatively low specification may be determined as the optimal vehicle type. For example, the vehicle corresponding to the graph 203 is a vehicle having the lowest technicality, reliability, and functionality compared to the vehicle corresponding to the graphs 202, 204, and 205. As described above, the vehicle model most suitable for the user tendency may be determined as the optimal vehicle type, but a vehicle relatively inferior to other vehicles may be determined as the optimal vehicle type by the user tendency.

The optimal tendency matcher 30 may calculate a sum of a result obtained by multiplying a weight value for each of the plurality of user tendency elements and a weight value for each of the plurality of vehicle tendency elements according to the factoring method for each vehicle. The optimal tendency matcher 30 may further generate the tendency matching index according to the calculated sum. A vehicle having the largest sum among the plurality of vehicles may be determined as the optimal vehicle type. According to the factoring method, the optimal vehicle type may be determined based on the user tendency and the vehicle tendency element having the highest weight value among the plurality of vehicle tendency elements. In other words, a vehicle that satisfies the user tendency among the plurality of vehicles and is relatively superior may be determined as the optimal vehicle type.

Table 6 is a table showing weight values for each user/vehicle tendency element for a plurality of vehicles and users. Table 6 shows the weight values for each user/vehicle tendency element of the graphs shown in FIG. 2. In

Table 6, “201” is the user tendency, and “202-205” are the vehicle tendencies.

TABLE 6

| | | | Self- | | | | |
|---|---|---|---|---|---|---|---|
| Classifi- | | | conscious- | | | Function- | |
| cation | Economics | Safety | ness | Technicality | Reliability | ality | Aesthetics |
| 201 | 2 | 1 | 1 | 1 | 0 | 2 | 1 |
| 202 | 3 | 2 | 3 | 2 | 3 | 3 | 1 |
| 203 | 2 | 2 | 1 | 0 | 1 | 1 | 2 |
| 204 | 2 | 3 | 3 | 2 | 3 | 3 | 1 |
| 205 | 3 | 2 | 3 | 5 | 3 | 3 | 3 |

Table 7 is a table showing a sum of a result obtained by multiplying a weight value for each of the plurality of user tendency elements and a weight value for each of the plurality of vehicle tendency elements according to the factoring method for each vehicle 202-205.

TABLE 7

| | | | Self- | | | | | |
|---|---|---|---|---|---|---|---|---|
| Classifi- | | | conscious- | | | Function- | | |
| cation | Economics | Safety | ness | Technicality | Reliability | ality | Aesthetics | Sum |
| 201*202 | 6 | 2 | 3 | 2 | 0 | 6 | 1 | 20 |
| 201*203 | 4 | 2 | 1 | 0 | 0 | 2 | 2 | 11 |
| 201*204 | 4 | 3 | 3 | 2 | 0 | 6 | 1 | 19 |
| 201*205 | 6 | 2 | 3 | 5 | 0 | 6 | 3 | 25 |

As can be seen from Table 7, the sum result of “205” among the plurality of vehicles, that is, the tendency matching index, is the highest. In other words, according to the factoring method, the vehicle corresponding to “205” may be determined as the optimal vehicle model. Like this, the optimal vehicle type “203” determined according to the standard deviation method and the optimal vehicle type “205” determined according to the factoring method may be different from each other.

The optimal tendency matcher 30 may generate the tendency matching index for the plurality of vehicles according to the factoring method, and may derive high rank vehicles among the generated tendency matching index as candidate vehicles. The optimal tendency matcher 30 may further generate the tendency matching index according to the standard deviation method for the candidate vehicles. For example, the optimal tendency matcher 30 may derive a predetermined number of high rank vehicles among the tendency matching index for the plurality of vehicles 202-205 derived according to the factoring method as candidate vehicles. In Table 7, two vehicles 202 and 205 having a high sum may be derived as candidate vehicles. The optimal tendency matcher 30 may generate the tendency matching index by calculating standard deviation for the candidate vehicles 202 and 205 according to the standard deviation method. Then, the candidate vehicle 202 having small standard deviation may be determined as the optimal vehicle type.

Like this, the optimal tendency matcher 30 may generate the tendency matching index according to each of the standard deviation method, the factoring method, and the hybrid method. Selecting one of the standard deviation method, the factoring method, and the hybrid method by the optimal tendency matcher 30 may be based on a user input from the user terminal 2. Alternatively, a duplicated vehicle may be selected as the optimal vehicle from among the optimal vehicle types according to the tendency matching index generated by the optimal tendency matcher 30 according to the standard deviation method, the factoring method, and the hybrid method. In addition, a method for determining the optimal vehicle type using the standard deviation method, the factoring method, and the hybrid method is not limited.

The vehicle recommendation system 1 may transmit information on the tendency matching index calculated by the optimal tendency matcher 30 to the user terminal 2. The application of the user terminal 2 may display the information on the plurality of received optimal candidate vehicles on the user terminal 2 so that the user may select the information. The user may select the optimal vehicle type based on the tendency matching index for the plurality of optimal candidate vehicles displayed on the user terminal 2. The application may transmit the optimal vehicle type selected by the user to the recommendation system 1 through the user terminal 2.

The vehicle recommendation system 1 according to an exemplary embodiment may further include the budget factor determinator 40.

The budget factor determinator 40 may derive budget factors for the plurality of vehicles before the optimal tendency matcher 30 generates the tendency matching index based on the user tendency and the vehicle tendency. In another embodiment, the budget factor determinator 40 may derive budget factors for the plurality of vehicles after the optimal tendency matcher 30 generates the plurality of tendency matching indexes for the plurality of vehicles. The budget factor means an index indicating the degree of matching between the user's budget for vehicle purchase (hereinafter, the budget for vehicle purchase) and vehicle price, and the user may determine whether the vehicle is within the available purchase range based on the budget factor.

When the budget factor is derived for the plurality of vehicles before the tendency matching index is generated, the optimal tendency matcher 30 may exclude a vehicle having the budget factor with less than a predetermined threshold value among the plurality of vehicles from matching tendency generation target. When the budget factor is derived after generating the tendency matching index, the tendency matching index for a vehicle having the budget factor with less than a predetermined threshold value becomes 0 regardless of the tendency matching index generated by the optimal tendency matcher 30. When the budget factor is derived for the plurality of vehicles before the tendency matching index is generated, the number of vehicles for generating the tendency matching index may be reduced, and thus the operation amount of the optimal tendency matcher 30 may be reduced.

The budget factor determinator 40 may determine the budget factor using at least one of the standard deviation method, the proportional calculation method, and the clustering method.

When the budget factor determinator 40 follows the standard deviation method, the budget factor determinator 40 may derive the vehicle price range applied a predetermined standard deviation to the budget for vehicle purchase (or budget range) received from the user terminal 2. When the vehicle price falls within the derived vehicle price range, the budget factor for the corresponding vehicle price may be derived using the budget factor function.

For example, the budget factor determinator 40 may derive a vehicle price range having standard deviation of a predetermined ratio based on the budget for vehicle purchase. The predetermined ratio is a value that can be changed according to the design, and acceptable budget range is investigated based on the vehicle price when purchasing a vehicle through a survey or accumulated big data, and a predetermined ratio may be set according to the survey result. The budget factor determinator 40 calculates standard deviation σ by multiplying the budget for vehicle purchase μ by a predetermined ratio, and the vehicle price range is set with a value μ-σ obtained by subtracting standard deviation σ from the budget for vehicle purchase μ as the lower limit and a value μ+σ obtained by adding standard deviation σ to the budget for vehicle purchase μ as the upper limit. The budget factor determinator 40 may derive the budget factor as 0 when the vehicle price is out of the vehicle price range. Then, when a difference between the user's budget for vehicle purchase and the vehicle price is large, the corresponding vehicle may be excluded from the user's selection target. The budget factor determinator 40 may derive the budget factor by using the probability density function. Equation 1 is a budget factor function formula. The budget factor function may be set such that the budget factor is 1 when the vehicle price is equal to the budget for vehicle purchase.

$$f ( x ) = {e}^{- \frac{{( x - μ )}^{2}}{2 {σ}^{2}}} \qquad [ Equation 1 ]$$

In Equation 1, x is the vehicle price, μ is the budget for vehicle purchase, σ is standard deviation, and f(x) is the budget factor as a budget factor function.

In a specific example for better understanding, if the budget for vehicle purchase μ is 30 million won and a predetermined ratio is 17%, standard deviation σ is 5.1 million won, and the lower limit μ-σ of the vehicle price range is 24.9 million won, and the upper limit μ+σ of the vehicle price range is 35.1 million won. If the vehicle price is less than 24.9 million won or exceeds 35.1 million won, the budget factor may be derived as 0. If the vehicle price is 27 million won, the budget factor is 0.841.

Alternatively, when the budget factor determinator 40 receives the budget range for vehicle purchase from the user terminal 2, it is possible to set the budget range for vehicle purchase as the vehicle price range, not necessary to set the vehicle price range. The budget factor determinator 40 may set a budget for vehicle purchase based on the budget range for vehicle purchase, and may derive standard deviation according to a difference between the budget range for vehicle purchase and the budget range for vehicle purchase. The budget factor determinator 40 may derive the budget factor by substituting standard deviation, the budget for vehicle purchase, and the vehicle price into the budget factor function of Equation 1. The budget factor determinator 40 may set a representative value indicating the budget range for vehicle purchase as the budget for vehicle purchase. For example, a representative value may be a median value.

In a specific example for better understanding, if the budget range for vehicle purchase is 27 million won to 33 million won, the budget for vehicle purchase p becomes 30 million won, and standard deviation σ is 3 million won, which is the difference between the minimum value and the maximum value of the budget range for vehicle purchase and the budget for vehicle purchase. Since the vehicle price range is the same as the budget range for vehicle purchase, the lower limit μ-σ of the vehicle price range is 27 million won, and the upper limit μ+σ of the vehicle price range is 33 million won. If the vehicle price is less than 27 million won or exceeds 33 million won, the budget factor may be derived as 0. If the vehicle price is 28.5 million won, the budget factor is 0.882.

The budget factor determinator 40 according to an embodiment may determine the budget factor according to a proportional calculation method. When the budget factor determinator 40 follows the proportional calculation method, a vehicle price range having a predetermined margin is derived based on the budget for vehicle purchase (or budget range) received from the user terminal 2. The budget factor proportional to the vehicle price may be derived when the vehicle price belongs to the proportional section among vehicle price range.

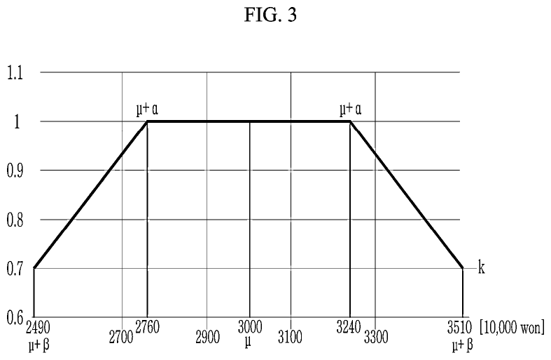

FIG. 3 is a graph illustrating a method of determining the budget factor according to the proportional calculation method by the budget factor determinator according to an embodiment.

In the graph shown in FIG. 3, the x-axis indicates the vehicle price range, and the y-axis indicates the budget factor. As shown in FIG. 3, the budget factor determinator 40 may derive the vehicle price range by setting a value obtained by subtracting a predetermined margin β from the budget for vehicle purchase p as the lower limit μ-β, and setting a value obtained by adding a predetermined margin β to the budget for vehicle purchase μ as the upper limit μ+β. The budget factor determinator 40 may calculate a predetermined margin β by multiplying the budget for vehicle purchase μ by a predetermined ratio. The predetermined ratio is a value that can be changed according to the design, and acceptable budget range is investigated based on the vehicle price when purchasing a vehicle through the survey or the accumulated big data, and a predetermined ratio may be set according to the survey result.

As shown in FIG. 3, the budget factor determinator 40 may set a range in which the budget factor is 1 (hereinafter, a budget factor fixed range) among the vehicle price ranges. The budget factor determinator 40 may derive the budget factor fixed range by setting a value obtained by subtracting a predetermined reference value a from the budget for vehicle purchase μ as the lower limit μ-α, and setting a value obtained by adding the predetermined reference value a to the budget for vehicle purchase μ as the upper limit μ+α. The budget factor determinator 40 may calculate a predetermined reference value a by multiplying the budget for vehicle purchase μ by a predetermined reference ratio. The predetermined reference ratio is a value that can vary depending on the design, and may be set to 8% in an embodiment. Considering that the acquisition tax is 7% and the public bond is around 10% of the acquisition tax, the budget factor fixed range which is a range where the budget does not affect vehicle purchase may be set when purchasing a vehicle. The budget factor determinator 40 may set the minimum value of the expected element. In an exemplary embodiments, the minimum value of the budget factor may be 0.7. When the vehicle price is less than the lower limit or the upper limit of the vehicle price range, the budget factor determinator 40 may determine the budget factor for the corresponding vehicle as 0.

In a specific example for better understanding, if the budget for purchasing a vehicle is 30 million won, the predetermined reference value a is 2.4 million won, the predetermined margin β is 5.1 million won, and k is 0.7. Then, as shown in FIG. 3, the vehicle price range is 24.9 million won to 35.1 million won, and the budget factor fixed range is 27.6 million won to 32.4 million won. In the proportional sections where the budget factor is proportional to the vehicle price, 24.9 million won to 27.6 million won and 32.4 million won to 35.1 million won, the budget factor determinator 40 may derive the budget factor for the vehicle by using the budget factor functions such as Equations 2 and 3 below. In Equations 2 and 3, x may be the vehicle price.

[Equation 2]

f(x)=k+(1-k)*(x-minimum value of vehicle price range)/α, (minimum value of vehicle price range≤x<minimum value of the budget factor fixed range)

[Equation 3]

f(x)=k+(1-k)*(the maximum value of vehicle price range-x)/α, (the maximum value of the budget factor fixed range <x≤the maximum value of vehicle price range)

Alternatively, when the budget factor determinator 40 receives the budget range for vehicle purchase from the user terminal 2, the budget factor determinator 40 may set the budget range for vehicle purchase as the vehicle price range, determine the budget factor for a vehicle falling within the vehicle price range as 1, and determine the budget factor for a vehicle out of the vehicle price range as 0.

In a specific example for better understanding, when the budget range for vehicle purchase is 27 million won to 33 million won, the vehicle price range may be the same as the budget range for vehicle purchase. When the vehicle price falls within the range of 27 million won to 33 million won, the budget factor for the vehicle may be derived as 1, and when the vehicle price is less than 27 million won or exceeds 33 million won, the budget factor for the vehicle may be derived as 0.

The budget factor determinator 40 according to an embodiment may determine the budget factor according to the clustering method. When the budget factor determinator 40 follows the clustering method, it is possible to derive the vehicle price range having the predetermined margin based on the budget for vehicle purchase (or budget range) received from the user terminal 2, and may divide the vehicle price range into a plurality of ranges. The budget factor determinator 40 may set the budget factor according to each range, and may also derive the budget factor of a range to which the vehicle price falls among the plurality of ranges as the budget factor of the vehicle.

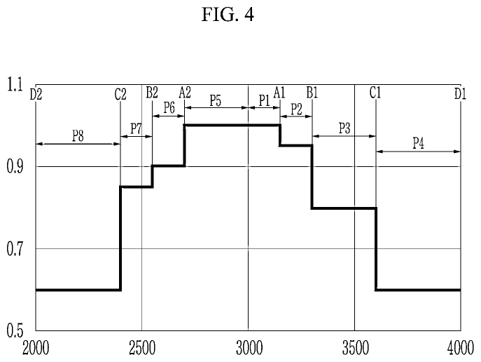

FIG. 4 is a graph illustrating a method of determining the budget factor according to the clustering method by the budget factor determinator according to an embodiment.

As shown in FIG. 4, the budget factor determinator 40 may set a plurality of ranges differently for the case where the vehicle price is high and the case where the vehicle price is low based on the budget for vehicle purchase. In FIG. 4, the budget for vehicle purchase may be 30 million won, and a predetermined margin may be 10 million won.

For example, when the vehicle price is higher than the budget for vehicle purchase, the budget factor determinator 40 may determine a value obtained by multiplying the budget for vehicle purchase by a predetermined first ratio (e.g., 8%) as a boundary value A1 of a first section P1. A first predetermined ratio may be determined to be 8% in consideration of the fact that the acquisition tax is 7% when purchasing a vehicle, and the public bond is about 10% of the acquisition tax. The budget factor determinator 40 may determine a value obtained by multiplying the budget for vehicle purchase by a predetermined second ratio (e.g., 10%) as a boundary value B1 of a seventh section P2. The second predetermined ratio may be determined to be 10% in consideration of the first predetermined ratio and the insurance cost of the vehicle. The budget factor determinator 40 may determine a value obtained by multiplying the budget for vehicle purchase by a predetermined third ratio (e.g., 20%) as a boundary value C1 of a third section P3. The predetermined third ratio may be determined in consideration of the economic burden felt by the user. The budget factor determinator 40 may determine a value obtained by multiplying the budget for vehicle purchase by a predetermined fourth ratio (e.g., 33.3%) as a boundary value D1 of a fourth section P4. The predetermined fourth ratio is a randomly set margin ratio. The budget factor of the first section P1 is 1, the budget factor of the second section P2 is 0.95, the budget factor of the third section P3 is 0.8, and the budget factor of the fourth section P4 is 0.6, and the budget factor of the vehicle price range higher than the fourth section P4 may be 0.

Next, when the vehicle price is lower than the budget for vehicle purchase, the budget factor determinator 40 may determine a value obtained by multiplying the budget for vehicle purchase by a predetermined fifth ratio (e.g., 10%) as a boundary value A2 of a fifth section P5. The first predetermined ratio may be determined to be 10% in consideration of the fact that the acquisition tax is 7% when purchasing a vehicle, and the public bond is about 10% of the acquisition tax. The budget factor determinator 40 may determine a value obtained by multiplying the budget for vehicle purchase by a predetermined sixth ratio (e.g., 15%) as a boundary value B2 of a sixth section. The predetermined sixth ratio may be determined based on a reference point at which a user's satisfaction with a vehicle having a lower price than the budget for vehicle purchase starts to decrease. The budget factor determinator 40 may determine a value obtained by multiplying the budget for vehicle purchase by a predetermined seventh ratio (e.g., 20%) as a boundary value C2 of a seventh section P7. The predetermined seventh ratio may be determined based on a critical point at which the user's satisfaction with a vehicle having a price lower than the budget for vehicle purchase rapidly decreases. The budget factor determinator 40 may determine a value obtained by multiplying the budget for vehicle purchase by a predetermined eighth ratio (e.g., 33.3%) as a boundary value D2 of a seventh section P8. The predetermined eighth ratio is a randomly set margin ratio. The budget factor of the fifth section P5 is 1, the budget factor of the sixth section P6 is 0.9, the budget factor of the seventh section P7 is 0.85, the budget factor of the eighth section P8 is 0.6, and the budget factor of the vehicle price range lower than the eighth section P8 may be 0.

The budget factors of the first to eighth sections P1 to P8 may be different from the values described above. For example, the budget factor of the fifth section P5 may have the highest value of 1.1.

The budget factor determinator 40 may determine a smaller value among the value obtained by subtracting a predetermined value from the budget for vehicle purchase and the value obtained by multiplying the budget for vehicle purchase by a predetermined ratio as the boundary value D2 of the eighth section P8. In this case, the predetermined value and the predetermined ratio may be determined based on the survey or the accumulated big data.

When receiving the budget range for vehicle purchase from the user terminal 2, the budget factor determinator 40 may set the budget range for vehicle purchase as the vehicle price range, and may determine the budget factor as 0 for the vehicle out of the vehicle price range. Further, the budget factor determinator 40 may determine the budget for vehicle purchase by multiplying the received median value of the budget range for vehicle purchase by a predetermined ratio. The budget factor determinator 40 may set the section from the minimum value of the budget range for vehicle purchase to the budget for vehicle purchase as the above-described fifth section P5, and may also set the section from the budget for vehicle purchase to the maximum value of the budget range for vehicle purchase as the above-described sixth section P6.

In an embodiment, a method of determining questions for determining user tendency (hereinafter, user tendency questions) is provided.

For example, the user tendency questions included in the user tendency test transmitted to the user terminal 2 by the vehicle recommendation system 1 may be questions determined by a method according to an exemplary embodiment.

The vehicle recommendation system 1 should derive the user tendency corresponding to the vehicle tendency through the user tendency question. Accordingly, the user tendency elements may be defined to correspond to the vehicle tendency elements. As mentioned above, in an embodiment, the vehicle tendency elements and the user tendency elements are the same, and the user tendency elements include economics, stability, self-consciousness, technicality, reliability, functionality, and aesthetics.

The user tendency determinator 10 according to an embodiment may generate a plurality of questions for the user tendency test. The user tendency determinator 10 may derive a related user tendency element and the sensitivity to the related user tendency element from among the user tendency elements for each of the plurality of questions.

Specifically, the user tendency determinator 10 may analyze responses of a plurality of populations to each of the plurality of questions to derive a response tendency to the questions of each population. Each of the plurality of populations may be divided into a group that values a specific tendency element among the user tendency elements. For example, the plurality of populations may include seven populations, and each of the seven populations may be a group that values one of economics, stability, self-consciousness, technicality, reliability, functionality, and aesthetics. The response tendency to the question of each population may mean a degree of agreement between responses of the corresponding population to the corresponding question. For example, it may be determined that the more the responses to a specific question in the population that value economics match, the higher the tendency for the specific question to be on economics. Then, the specific question may be defined as an economics question.

The user tendency determinator 10 may match the user tendency element to which each of the plurality of questions belongs to each of the plurality of questions based on the response tendency to each of the plurality of questions. The user tendency determinator 10 may quantify the user tendency element corresponding to each of the plurality of questions and the sensitivity between each question based on the response tendency. The user tendency determinator 10 may increase the sensitivity as the response tendency increases. For example, when analyzing the response tendency to the questions of “I value economics” and “If I can save time, I can bear the cost even if it costs a little more” to a population that values economics, the tendency to respond positively to the former question may be stronger than the tendency to respond positively to the latter question. Then, the user tendency determinator 10 may determine the sensitivity to the economics of the former question to be higher than the sensitivity for the economics of the latter question.

The user tendency determinator 10 may configure a question set by classifying the plurality of questions according to the sensitivity in consideration of the sensitivity of each of the plurality of questions for each user tendency element. For example, Table 8 shows the sensitivity of each of the plurality of questions according to the user tendency element.

TABLE 8

| Classifi- | Question | Question | Question | Question | Question | Question | Question |
|---|---|---|---|---|---|---|---|
| cation | 1 | 2 | 3 | 4 | 5 | 6 | 7 |
| Econom- | 1 | 3 | 4 | 1 | 1 | 2 | 5 |
| ics | | | | | | | |
| Safety | 3 | 3 | 2 | 5 | 3 | 4 | 1 |
| Self- | 5 | 2 | 3 | 5 | 4 | 1 | 2 |
| conscious- | | | | | | | |
| ness | | | | | | | |
| Techni- | 1 | 5 | 1 | 2 | 3 | 4 | 1 |
| cality | | | | | | | |

Table 9 shows that the user tendency determinator 10 classifies questions according to sensitivity for each user tendency element.

TABLE 9

| Sensitivity | 1 | 2 | 3 | 4 | 5 |
|---|---|---|---|---|---|
| Economics | Questions | Question 6 | Question 2 | Question 3 | Question 7 |
| | 1, 4, 5 | | | | |
| Safety | Question 7 | Question 3 | Question | Question 6 | Question 4 |
| | | | 1, 2, 5 | | |
| Self- | Question 6 | Questions | Question 3 | Question 5 | Questions |
| conscious- | | 2, 7 | | | 1, 4 |
| ness | | | | | |
| Technicality | Questions | Question 4 | Question 5 | Question 6 | Question 2 |
| | 1, 3, 7 | | | | |

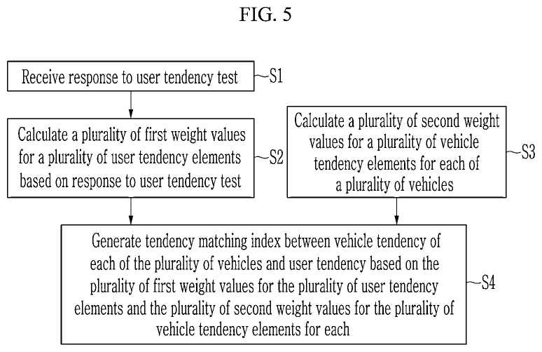

FIG. 5 is a flowchart illustrating a vehicle recommendation method according to an exemplary embodiment.

First, the user tendency determinator 10 receives a response to the user tendency test from the user terminal 2 (operation S1).

The user tendency determinator 10 may calculate a plurality of first weight values for the plurality of user tendency elements based on the response to the user tendency test (operation S2).

The vehicle tendency determination device 20 may calculate a plurality of second weight values for the plurality of vehicle tendency elements for each of the plurality of vehicles (operation S3).

The optimal tendency matcher 30 may generate the tendency matching index between the vehicle tendency of each of the plurality of vehicles and the user tendency based on the plurality of first weight values for the plurality of user tendency elements and the plurality of second weight values for the plurality of user tendency elements for each of the plurality of vehicles (operation S4).

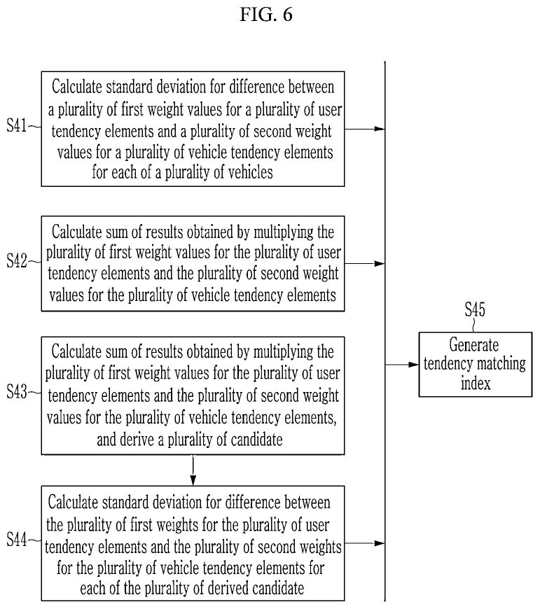

FIG. 6 is a diagram illustrating a method of generating the tendency matching index.

Operation S4 may be performed according to one of the three methods shown in FIG. 6. One of S41, S42, and S43-S44 shown in FIG. 6 may be optionally performed as operation S4.

In operation S41, the optimal tendency matcher 30 may calculate standard deviation for a difference between the plurality of first weight values for the plurality of user tendency elements and the plurality of second weight values for the plurality of vehicle tendency elements for each of the plurality of vehicles.

In operation S42, the optimal tendency matcher 30 may calculate the sum of the result obtained by multiplying the plurality of first weight values for the plurality of user tendency elements and the plurality of second weight values for the plurality of vehicle tendency elements.

In operation S43, the optimal tendency matcher 30 may calculate the sum of the result obtained by multiplying the plurality of first weight values for the plurality of user tendency elements and the plurality of second weight values for the plurality of vehicle tendency elements, and may derive a predetermined number of high rank vehicles as candidate vehicles from among the sum for the plurality of vehicles. In operation S44, the optimal tendency matcher 30 may calculate standard deviation for a difference between the plurality of first weights for the plurality of user tendency elements and the plurality of second weights for the plurality of vehicle tendency elements for each of the plurality of candidate vehicles.

The optimal tendency matcher 30 may generate the tendency matching index according to the values calculated in operations S41, S42, and S43-S44 (operation S45).

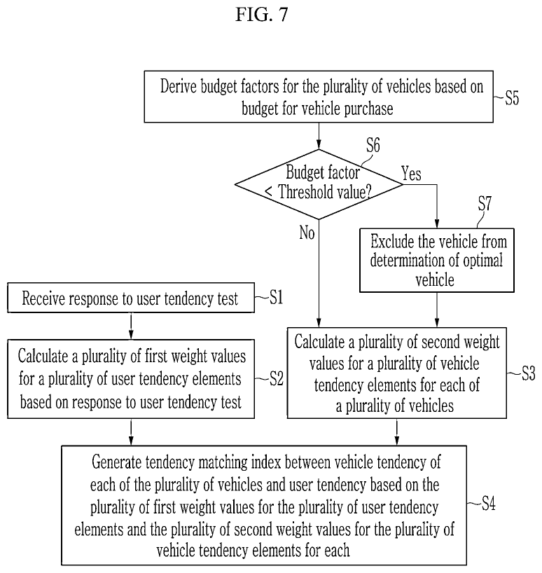

FIG. 7 is a flowchart illustrating the vehicle recommendation method in consideration of the budget factor according to an embodiment.

The budget factor determinator 40 may derive budget factors for the plurality of vehicles based on the budget for vehicle purchase received from the user terminal 2 (operation S5).

The budget factor determinator 40 may determine whether the budget factor is less than a predetermined threshold value (operation S6).

As a determination result in operation S6, when the budget factor is less than the threshold value, the corresponding vehicle may be excluded from the determination of the optimal vehicle (operation S7). After operation S7, operation S3 may be performed.

As a result of the determination in operation S6, if the budget factor is equal to or greater than the threshold value, operation S3 may be performed.

Since the description of operation S4 is the same as that of FIG. 5, a detailed description thereof has been omitted.

As described above, the vehicle tendency determination device 20 may calculate weight values for the plurality of vehicle tendency elements based on the vehicle data and the vehicle evaluation data. The manner may vary and is not limited to the manner stated in the specification. In order to help the understanding of the present disclosure, a method of determining a weight value for economics among the plurality of vehicle tendency elements is described below in detail.

The vehicle tendency determination device 20 may determine a weight value for economics, which is one of the vehicle tendency elements, based on the vehicle price and the maintenance cost for a predetermined period among the vehicle data. Here, the vehicle price may be a cost used when purchasing the vehicle (hereinafter, vehicle purchase cost). In addition, the maintenance cost is the cost required to use the vehicle during the vehicle replacement period (hereinafter, the vehicle maintenance cost), and the vehicle replacement period may be the period from the time of vehicle purchase to the time of selling the vehicle and replacing it with another vehicle. The vehicle replacement period may be a predetermined period, or may be input from the user through the user terminal 2.

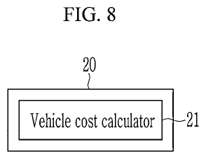

FIG. 8 is a block diagram illustrating a configuration of a part of the vehicle tendency determination device according to an embodiment.

The vehicle tendency determination device 20 may include a vehicle cost calculator 21 in order to determine a weight value for economics.

The vehicle cost calculator 21 may calculate the vehicle purchase cost and the vehicle maintenance cost.

The vehicle cost calculator 21 may calculate the vehicle purchase cost by summing up the vehicle price and vehicle registration cost.

The vehicle cost calculator 21 may calculate the vehicle price by adding the price of optional specifications to a vehicle trim price based on information on a vehicle trim and the applied option specifications. The vehicle cost calculator 21 may add a consignment fee to the vehicle price. The consignment fee is the cost of delivering the vehicle from the factory to the user. The vehicle cost calculator 21 may deduct a predetermined discount cost from the vehicle price.

The vehicle cost calculation unit 21 may calculate the vehicle registration cost by adding the acquisition tax, the public bond, and extra cost. The acquisition tax is a tax that must be paid when acquiring a vehicle and may vary depending on displacement of the vehicle. The public bond is the bond that are mandatory to purchase when purchasing a vehicle, and since the public bond is sold immediately at a predetermined discount rate after purchase, a public bond cost may be calculated based on a selling price. Extra cost includes license plate cost, registration agent cost, stamping, etc.

The vehicle cost calculator 21 may calculate the vehicle maintenance cost by summing up fuel cost, insurance premium, vehicle tax, and repair cost during the vehicle replacement period after vehicle purchase.

The vehicle cost calculator 21 may obtain information on unit fuel cost, for example, oil price per liter, electric vehicle charging rate per 1 kWh, and hydrogen charging rate per kg in real time, and calculate the fuel cost during the replacement period using the obtained information according to fuel of the vehicle. The vehicle cost calculator 21 may obtain the fuel cost announced on the site by using a site or an application operated by each company that supplies each fuel. For example, the vehicle cost calculator 21 may obtain oil price information from the Korea National Oil Corporation website for information on oil price, acquire electric vehicle charging rate information from the electricity rate table announced on the Korea Electric Power Corporation website, and obtain information on hydrogen charging rate through the application provided by the hydrogen charging station H2 Care. The vehicle cost calculator 21 may estimate fuel amount based on the travel distance during the vehicle replacement period, and may calculate fuel cost during the vehicle replacement period by multiplying fuel amount by one of oil price, electric vehicle charging rate, and the hydrogen charging rate according to the vehicle type. The travel distance during the vehicle replacement period may be set to a predetermined distance or be input from the user through the user terminal 2. The vehicle cost calculator 21 may estimate the required fuel amount by dividing the travel distance by the fuel efficiency.

The vehicle cost calculator 21 may estimate the fuel efficiency based on the information on the annual travel distance received from the user terminal 2. The vehicle cost calculator 21 may calculate a city driving ratio and a highway driving ratio from the user's driving pattern according to the user's annual travel distance. Since certified fuel efficiency for city driving (hereinafter, city driving fuel efficiency) and certified fuel efficiency for highway driving (hereinafter, highway driving fuel efficiency) are set for each vehicle, the vehicle cost calculator 21 may determine the final fuel efficiency by summing up a value obtained by multiplying the city driving ratio by the city driving fuel efficiency and a value obtained by multiplying the highway driving ratio by the highway driving fuel efficiency.

Specifically, the vehicle cost calculator 21 may first set a first reference distance in which the city driving ratio is 100% and a second reference distance in which the highway driving ratio is 100%. For example, the first reference distance RD1 may be 3000 km, and the second reference distance RD2 may be 50000 km. In actual driving, there is no case where only city driving is 100% or only highway driving is 100%, but in general, if the annual travel distance is 3,000 km or less, it may be assumed that highway is substantially not used, and if the annual travel distance is 50,000 km or more, it may be assumed that it is substantially not driven in the city. The vehicle cost calculator 21 may calculate the city driving ratio RCD and the highway driving ratio RHD according to Equation 4 below.

[Equation 4]

RCD=(DD-RD1)/(RD2-RD1), RHD=1-RCD

In Equation 4, DD is the annual travel distance, when DD is 3000 km or less, the vehicle cost calculator 21 may determine RCD as 1 and RHD as 0 without using Equation 4, and when DD is 50000 km or more, the vehicle cost calculator 21 may determine RCD as 0 and RHD as 1 without using Equation 4.

The vehicle cost calculator 21 may determine the final fuel efficiency FFE according to Equation 5 below. In Equation 5, FE1 is city driving fuel efficiency, and FE2 is highway driving fuel efficiency.

[Equation 5]

FFE=FE1*RCD+FE2*RHD

If the annual travel distance of the Genesis G80 2.5T gasoline vehicle is 30000 km, the city fuel efficiency is 9.2 km/L, and the highway driving fuel efficiency is 12.6 km/L, then FE1 is 0.43 and FE2 is 0.57, so the final fuel efficiency may be determined as 11.2 km/L (=0.43+9.2 km/L+0.57*12.6 km/L).

The vehicle cost calculator 21 may calculate the fuel cost during the vehicle replacement period by multiplying the annual fuel amount obtained by dividing the annual travel distance by the fuel efficiency by the unit fuel cost and the vehicle replacement period. For example, if the annual travel distance of the

Genesis G80 2.5T gasoline vehicle is 30000 km, the fuel efficiency is 11.2 km/L, the unit fuel cost is 2000 won/L, and the vehicle replacement period is 5 years, then the fuel cost during the vehicle replacement period may be calculated as approximately 26.79 million won according to the formula of (30000 km/year)/(11.2km/L)*(2000won/L)*5 years.

The vehicle cost calculator 21 may obtain the insurance premium based on the insurance class, price, and extra charge factor of the vehicle. The vehicle cost calculator 21 may transmit information necessary for calculating insurance premium to an external server to request for calculating insurance premium. The information required for calculating insurance premium may include the vehicle type, the vehicle price, the vehicle trim and option use, and the like. The vehicle cost calculator 21 may receive insurance premium from the external server. The insurance grade of the vehicle may be determined based on a traffic accident rate of the vehicle. Instead of the insurance grade of the vehicle, the safety grade of the vehicle may be used to calculate insurance premium.

The vehicle cost calculator 21 may calculate the vehicle tax according to the local tax law according to the use of the vehicle, the displacement, and the vehicle replacement period. The use of the vehicle can be divided into commercial use and non-commercial use.

The vehicle cost calculator 21 may calculate the cost required for repair of consumables by using a vehicle manufacturer's manual and a site or application operated by a company that provides a repair service.

The vehicle cost calculator 21 calculates a total cost obtained by summing up the vehicle purchase cost and the vehicle maintenance cost. The vehicle tendency determination device 20 may determine a weight value for the economics of the vehicle based on the total cost. Alternatively, the vehicle tendency determination device 20 may determine a weight value for the economics of the vehicle based on a cost obtained by subtracting used price at the time when the vehicle replacement period has elapsed from the total cost.

According to the present disclosure, it is possible to minimize the existing complicated vehicle purchase process, and to reduce dissatisfaction when selecting a vehicle by mistake. Furthermore, according to the present disclosure, it is possible to determine the user tendency, match the vehicle tendency to the user tendency, determine a vehicle suitable for the user tendency, and to perform a one-stop operation until shipment.

In addition, unlike the existing discount-oriented new car sales platform, it is possible to provide time and financial benefits to users, and also increase users' satisfaction with new car purchase.

While this present disclosure has been described in connection with what is presently considered to be practical embodiments, it is to be understood that the present disclosure is not limited to the disclosed embodiments. On the contrary, it is intended to cover various modifications and equivalent arrangements included within the spirit and scope of the present disclosure.

<Description of symbols>
1: Vehicle recommendation system
10: User tendency determinator
20: Vehicle tendency determination device
30: Optimal tendency matcher
40: Budget factor determinator
21: Vehicle cost calculator

What is claimed is:

1. A vehicle recommendation system, comprising:
a user tendency determinator configured to determine a user tendency based on a response to a user tendency test received from a user terminal;
a vehicle tendency determination device configured to determine a plurality of vehicle tendencies for each of a plurality of vehicles; and
an optimal tendency matcher configured to generate a tendency matching index indicating a degree of matching between the user tendency and the vehicle tendency for each of the plurality of vehicles.

2. The vehicle recommendation system of claim 1, wherein:
the user tendency determinator is configured to calculate a plurality of first weight values for a plurality of user tendency elements of the user tendency based on the response to the user tendency test,
the vehicle tendency determination device is configured to calculate a plurality of second weight values for a plurality of vehicle tendency elements of each of the plurality of vehicles, and
the optimal tendency matcher is configured to generate the tendency matching index for each of the vehicles based on the plurality of first weight values for the plurality of user tendency elements and the plurality of second weight values for the plurality of vehicle tendency elements for each of the plurality of vehicles.

3. The vehicle recommendation system of claim 2, wherein:
the user tendency determinator is configured to:
sum the plurality of first weight values in a result of the response to the user tendency test for each of the user tendency elements,
compare a result of the sum with a score distribution for each of the user tendency elements of each of a plurality of user tendency groups, and
determine that a user belongs to one of the plurality of user tendency groups that shows a most similar score distribution to the result of the sum based on the comparison.

4. The vehicle recommendation system of claim 3, wherein:
the user tendency determinator is configured to:
derive a weight value distribution of the plurality of user tendency elements for each of a plurality of users, and
determine characteristics of each of the plurality of user tendency groups by grouping the plurality of user tendency elements according to the derived weight value distribution of the plurality of user tendency elements.

5. The vehicle recommendation system of claim 2, wherein:
the user tendency determinator is configured to:
sum a result obtained by multiplying a response to each of a plurality of questions included in the user tendency test and sensitivity for each of the plurality of user tendency elements of each question, and
determine the user tendency based on a result of the sum for each of the plurality of user tendency elements.

6. The vehicle recommendation system of claim 2, wherein:
the vehicle tendency determination device is configured to calculate the plurality of second weight values for the plurality of vehicle tendency elements based on vehicle data for each of the plurality of vehicles and vehicle evaluation data for each of the plurality of vehicles,
the vehicle data includes at least one of vehicle specifications, price, color, performance, or maintenance cost, and
the vehicle evaluation data includes at least one of evaluation data for each vehicle provided by a vehicle evaluation institution and evaluation data collected from users.

7. The vehicle recommendation system of claim 2, wherein:
the optimal tendency matcher is configured to generate the tendency matching index by calculating standard deviation for differences between the plurality of first weight values for the plurality of user tendency elements and the plurality of second weight values for the plurality of vehicle tendency elements for each of the plurality of vehicles.

8. The vehicle recommendation system of claim 2, wherein:
the optimal tendency matcher is configured to generate the tendency matching index by calculating a sum of results obtained by multiplying the plurality of first weight values for the plurality of user tendency elements and the plurality of second weight values for the plurality of vehicle tendency elements.

9. The vehicle recommendation system of claim 2, wherein:
the optimal tendency matcher is configured to:
calculate a sum of results obtained by multiplying the plurality of first weight values for the plurality of user tendency elements and the plurality of second weight values for the plurality of vehicle tendency elements,
derive a plurality of candidate vehicles among the plurality of vehicles based on the sum, and
generate the tendency matching index by calculating standard deviation for differences between the plurality of first weight values for the plurality of user tendency elements and the plurality of second weight values for the plurality of vehicle tendency elements for each of the plurality of derived candidate vehicles.

10. The vehicle recommendation system of claim 1, further comprising:
a budget factor determinator configured to derive a budget factor for the plurality of vehicles,
wherein the budget factor is an index indicating a degree to which a user's budget for vehicle purchase matches vehicle price.

11. The vehicle recommendation system of claim 10, wherein:
the budget factor determinator is configured to:
derive a vehicle price range obtained by applying predetermined standard deviation to the budget for vehicle purchase received from the user terminal, and
derive the budget factor for the vehicle price using a budget factor function when the vehicle price belongs to the derived vehicle price range.

12. The vehicle recommendation system of claim 10, wherein:
the budget factor determinator is configured to:
receive a budget range for vehicle purchase from the user terminal,
set the budget for vehicle purchase based on the budget range for vehicle purchase,
set the budget range for vehicle purchase as a vehicle price range,
derive standard deviation according to a difference between the budget range for vehicle purchase and the budget for vehicle purchase, and
derive the budget factor based on the budget for vehicle purchase, the standard deviation, and the vehicle price.

13. The vehicle recommendation system of claim 10, wherein:
the budget factor determinator is configured to:
receive the budget for vehicle purchase from the user terminal,
derive a vehicle price range having a predetermined margin based on the budget for vehicle purchase, and
derive the budget factor proportional to the vehicle price when the vehicle price falls within a proportional section of the vehicle price range.

14. The vehicle recommendation system of claim 10, wherein:
the budget factor determinator is configured to:
receive a budget range for vehicle purchase from the user terminal,
set the budget range for vehicle purchase as a vehicle price range,
determine the budget factor as one (1) for the vehicle falling within the vehicle price range, and
determine the budget factor as zero (0) for the vehicle beyond the vehicle price range.

15. The vehicle recommendation system of claim 10, wherein:
the budget factor determinator is configured to:
receive the budget for vehicle purchase from the user terminal,
derive a vehicle price range having a predetermined margin based on the budget for vehicle purchase,
divide the vehicle price range into a plurality of ranges to set the budget factor according to each range, and
derive the budget factor of the range to which the vehicle price belongs of the plurality of ranges as the budget factor of the vehicle.

16. The vehicle recommendation system of claim 10, wherein:
the budget factor determinator is configured to:
receive a budget range for vehicle purchase from the user terminal,
determine the budget for vehicle purchase by multiplying a median value of the budget range for vehicle purchase by a predetermined ratio, and
set the budget factor according to a section from the minimum value of the budget range for vehicle purchase to the budget for vehicle purchase and a section from the budget for vehicle purchase to the maximum value of the budget range for vehicle purchase.

17. The vehicle recommendation system of claim 1, wherein:
the vehicle tendency determination device comprises a vehicle cost calculator configured to calculate vehicle purchase cost and vehicle maintenance cost to calculate a weight value for economics among the vehicle tendencies, and
the vehicle cost calculator is configured to calculate the vehicle purchase cost by summing up vehicle price and vehicle registration cost and calculate the vehicle maintenance cost by summing up at least two of fuel cost, insurance premium, tax imposed on the vehicle, and repair cost during a predetermined vehicle replacement period.

18. The vehicle recommendation system of claim 17, wherein:
the vehicle cost calculator is configured to:
calculate fuel efficiency based on annual travel distance received from the user terminal to calculate the fuel cost based on the fuel efficiency, and
calculate a city driving ratio by dividing a difference between the annual travel distance and a first reference distance by a difference between a second reference distance and the first reference distance,
calculate a highway driving ratio by deducting the city driving ratio from one (1), and
calculate the fuel efficiency by summing up a value obtained by multiplying the city driving ratio and city driving fuel efficiency and a value obtained by multiplying the highway driving ratio and highway driving fuel efficiency.

19. The vehicle recommendation system of claim 18, wherein:
the first reference distance is determined based on the annual travel distance in which the city driving ratio is one (1), and the second reference distance is determined based on the annual travel distance in which the highway driving ratio is one (1).

20. A vehicle recommendation method, comprising:
receiving a response to a user tendency test from a user terminal;
determining a user tendency based on a response to a user tendency test;
determining a plurality of vehicle tendencies for each of a plurality of vehicles; and
generating a tendency matching index indicating a degree of matching between the user tendency and the vehicle tendency for each of the plurality of vehicles.

21. The vehicle recommendation method of claim 20, wherein
generating the tendency matching index comprises generating the tendency matching index based on a plurality of first weight values for a plurality of user tendency elements of the user tendency and a plurality of second weight values for a plurality of vehicle tendency elements for each of the plurality of vehicles.

22. The vehicle recommendation method of claim 21, wherein
generating the tendency matching index comprises calculating standard deviation for differences between the plurality of first weight values for the plurality of user tendency elements and the plurality of second weight values for the plurality of vehicle tendency elements for each of the plurality of vehicles.

23. The vehicle recommendation method of claim 21, wherein
generating the tendency matching index comprises calculating a sum of results obtained by multiplying the plurality of first weight values for the plurality of user tendency elements and the plurality of second weight values for the plurality of vehicle tendency elements.

24. The vehicle recommendation method of claim 20, wherein
generating the tendency matching index comprises:
calculating a sum of result obtained by multiplying a plurality of first weight values for a plurality of user tendency elements and a plurality of second weight values for a plurality of vehicle tendency elements;
deriving a plurality of candidate vehicles among the plurality of vehicles based on the sum; and
calculating standard deviation for differences between the plurality of first weight values for the plurality of user tendency elements and the plurality of second weight values for the plurality of vehicle tendency elements for each of the plurality of derived candidate vehicles.

25. The vehicle recommendation method of claim 20, further comprising:
deriving a budget factor for each of the plurality of vehicles; and
excluding a vehicle having the budget factor less than a predetermined threshold value among the plurality of vehicles at the generating of the tendency matching index.
